(19) United States
(12) Patent Application Publication
(10) Pub. No.: US 2008/0072970 A1
(43) Pub. Date: Mar. 27, 2008

(54) Foot Pedal for Controlling Flow of Liquid Fluid in Arthroscopic Surgery

(75) Inventors: Seth Gasser, Tampa, FL (US); Sergio Gutierrez, Tampa, FL (US)

Correspondence Address: SMITH HOPEN, PA, 180 PINE AVENUE NORTH, OLDSMAR, FL, 34677, US

(73) Assignee: HEALTHCARE CREATIONS, LLC, Tampa, FL (US)

(21) Appl. No.: 11/860,036

(22) Filed: Sep. 24, 2007

Related U.S. Application Data
(60) Provisional application No. 60/826,784, filed on Sep. 25, 2006.

(51) Int. Cl. F16K 15/18

(52) U.S. Cl. 137/467.5; 251/174; 600/112; 74/512

(57) ABSTRACT

A foot pedal evacuates debris and fluid from the field of view of a camera during arthroscopic procedures. In a first embodiment, the foot pedal houses a ball check valve to control fluid flow, and includes a base and a foot support hingedly mounted to one another. The foot support includes a valve actuator that opens the ball check valve by distorting the shape of its valve seat. The ball check valve includes a pair of connectors at the ends of the valve adapted to accept irrigation tubing. The connectors are in axial alignment with one another in a first embodiment and in parallel relation to one another in a second embodiment. A third embodiment eliminates the ball check valve and a spring-loaded lever pinches a tube to prevent fluid flow. Depression of the foot support overcomes the bias of the spring so that liquid fluid flows through the tube.

### CROSS REFERENCE TO RELATED APPLICATIONS

This application claims priority to currently pending U.S. Provisional Patent Application 60/826,784, entitled: “Foot Pedal to Aid in Arthroscopic Surgery,” filed Sep. 25, 2006.

### BACKGROUND OF THE INVENTION

1. Field of the Invention

This invention relates to equipment used in surgical procedures. More particularly, it relates to a foot-actuated control valve for use during arthroscopic procedures to effect a controlled purge and replenishment of liquid fluid from the field of view of a camera employed during surgery to view the surgical site.

2. Description of the Prior Art

Arthroscopes and other optical instruments such as endoscopes are in common use by orthopedic surgeons because they enable minimally invasive surgery and the many benefits that flow therefrom. For example, the use of such instruments reduces the amount of time required to perform a surgical operation, reduces the patient's recovery time, reduces the post-operative pain experienced by patients, and is less expensive than traditional surgery. Moreover, the surgery can often be handled on an outpatient basis.

In arthroscopic surgery, an arthroscope is used to assist in the visual inspection of a joint such as a knee or shoulder joint. The procedure begins with an incision into the joint, and sterile fluid, typically saline, is introduced into the joint space to provide a better view. The arthroscope is then inserted and the inside of the joint is viewed by displaying the image on a monitor. During the procedure tissue and other debris accumulate in the fluid at the site of the procedure and interferes with the field of vision. To clear the view, the fluid at the site is purged and additional sterile fluid is delivered to the site. A fluid circuit is maintained with sterile fluid provided by a remote reservoir in fluid communication with an inlet of the scope. The fluid is thus delivered from the reservoir to the field of view. The circuit further includes an outlet from the field of view for purging the discharge fluid to a remote receptacle or collection tank for discard. The system typically operates under suction with control provided by a stopcock or other hand-controlled valve assembly downstream of the field of view. When the valve is closed, the fluid is statically maintained within the site of the procedure. The surgeon manually opens the stopcock to flush the site and deliver additional fluid. The suction pulls the fluid from the site and delivers fresh fluid from the reservoir of sterile fluid. The surgeon closes the valve to stop the suction when the site is sufficiently flushed. The focus of the arthroscope is then typically readjusted and the procedure is continued.

Current instrumentation for arthroscopy includes at least three hand-actuated devices that the surgeon cannot manipulate simultaneously. The devices are a camera, at least one surgical tool, and a stopcock. During the procedure the surgeon typically operates the camera with one hand and manipulates the surgical instruments, such as a shaver or biter, with the other hand. To operate the stopcock or other hand-controlled valve assembly, the surgeon must put down either the camera or the surgical instrument to free a hand. If the inlet stopcock is left open, the opening of the outlet stopcock purges the field of view of the fluid to be discarded and delivers sterile fluid to the surgical site. The surgeon must then manually close the outlet stopcock and retrieve the surgical instrument. A typical surgical procedure may require about thirty of such purges, causing the surgeon to have to put down and pick up the surgical instrument that many times. Such action diverts the surgeon's attention from the field of view each time a purge is required and thus increases the time required to complete the procedure.

A system is needed that enables a surgeon to purge the field of view without requiring the surgeon to free a hand and divert attention.

It would be further desirable to have a system that allows the surgeon a degree of control over the applied suction, facilitating controlled delivery of fresh fluid.

However, in view of the prior art considered as a whole at the time the present invention was made, it was not obvious to those of ordinary skill how the identified needs could be fulfilled.

### SUMMARY OF INVENTION

The long-standing but heretofore unfulfilled need for improvements in the field of arthroscopy is now met by a new, useful, and nonobvious invention.

The novel structure includes a foot-actuated control valve assembly, also referred to herein as a foot pedal, adapted to evacuate debris and fluid from the field of view so that a surgeon's hands are not involved in the purge procedure. In a first embodiment, the structure includes a ball check valve that controls the flow of fluid, an annular check valve seat, and a foot pedal formed by a foot support hingedly secured to a base. The foot support includes a valve actuator that opens the ball check valve by distortion of the check valve seat from its annular configuration responsive to application of pressure to the foot support.

The ball check valve includes a pair of connectors, also known as tube mounts, at the opposite ends of the valve assembly adapted to accept inlet and outlet irrigation tubes or hoses. In a first embodiment, the tube mounts are straight in configuration and are axially aligned with one another. In a second embodiment, the tube mounts have a ninety degree (90°) bend formed in them so that the inlet and outlet irrigation tubes or hoses are disposed in parallel relation to one another.

The base includes a pair of clips to secure the valve within the base of the foot pedal. The top surface of the foot support is textured to facilitate the placement of the foot of a user and inhibit slippage. The base and the foot support are fabricated of disposable plastic to make the unit suitable for one-time use followed by disposal. In a second embodiment, the ball check valve is replaced by a simple tube and a spring-loaded lever that pinches the tube in a normally closed configuration when the spring is in repose. Stepping on the foot pedal pivots the lever so that the bias of the spring is overcome and liquid fluid can flow through the tube.

### BRIEF DESCRIPTION OF THE DRAWINGS

For a fuller understanding of the invention, reference should be made to the following detailed description, taken in connection with the accompanying drawings, in which:

FIG. 1 is a diagrammatic view of an illustrative embodiment of the invention;

FIG. 2 is a diagrammatic view similar to that of FIG. 1 but with the reservoir and collection tank omitted;

FIG. 3A is a perspective view of a first embodiment of the novel foot pedal;

FIG. 3B is a perspective view of a second embodiment of the novel foot pedal;

FIG. 3C is a perspective view of a third embodiment of the novel foot pedal;

FIG. 3D is a perspective view of a fourth embodiment of the novel foot pedal;

FIG. 3E is a perspective view of a fifth embodiment of the novel foot pedal;

FIG. 4A is a perspective view of a first embodiment of the novel foot pedal base;

FIG. 4B is a perspective view of a second embodiment of the novel foot pedal base;

FIG. 4C is a perspective view of a third embodiment of the novel foot pedal base;

FIG. 5A is a perspective view of a first embodiment of the underside of the novel foot support;

FIG. 5B is a perspective view of a second embodiment of the underside of the novel foot support;

FIG. 5C is a perspective view of a third embodiment of the underside of the novel foot support;

FIG. 6A is a longitudinal sectional view depicting the valve assembly that is opened and closed by the novel foot pedal;

FIG. 6B is a perspective view of the valve assembly of FIG. 6A;

FIG. 6C is an elevational view depicting the valve assembly of FIGS. 6A and 6B when installed in the base of the novel foot pedal;

FIG. 7A is a diagrammatic top plan view of a second embodiment of the valve assembly;

FIG. 7B is a diagrammatic side elevational view of the second embodiment of the valve assembly;

FIG. 7C is a diagrammatic front elevational view of the second embodiment of the valve assembly;

FIG. 8A is a perspective view of the third embodiment of the invention;

FIG. 8B is a side elevational view of said third embodiment;

FIG. 9A is a perspective view of the third embodiment with the foot support removed;

FIG. 9B is a perspective view like FIG. 9A but with the lever and related parts removed; and

FIG. 9C is a top plan view of the parts depicted in FIG. 9B.

### DETAILED DESCRIPTION OF THE PREFERRED EMBODIMENT

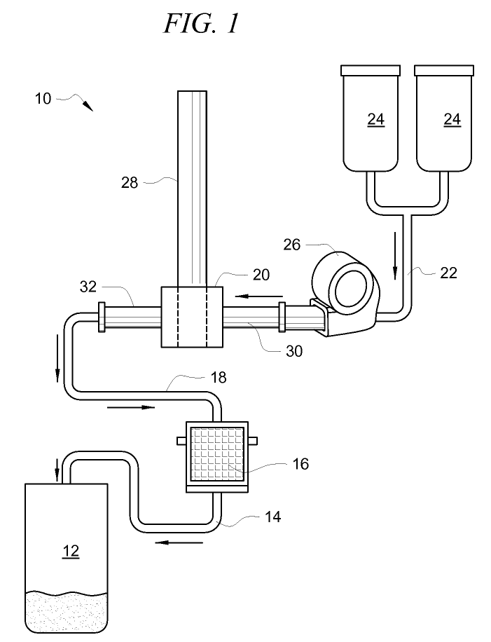

Referring now to FIG. 1, there it will be seen that the novel system is denoted as a whole by the reference numeral 10.

The interior of waste-collection tank 12 is under suction, i.e., a suitable vacuum pump, not shown, is employed to maintain said interior below atmospheric pressure. Hose or tubing 14 provides fluid communication between tank 12 and an outlet port of novel foot pedal 16. Hose or tubing 18 provides fluid communication between an inlet port of foot pedal 16 and outlet stopcock 32 of camera 20, and hose or tubing 22 provides fluid communication between inlet stopcock of 30 camera 20 and a source of sterile solution 24, 24.

Instead of maintaining tank 12 under negative pressure, positive pressure pump 26 may be positioned between sterile solution 24 and inlet stopcock 30.

Foot pedal 16 is the actuator for a normally closed valve, not depicted in FIG. 1, that prevents flow of sterile solution from source 24 when said valve is in its closed position of repose. When actuated by a surgeon's foot, said normally closed valve opens and the pressure in hose 22, and the suction in hose 14, causes flow of sterile solution 24 through camera 20 and into waste collection tank 12.

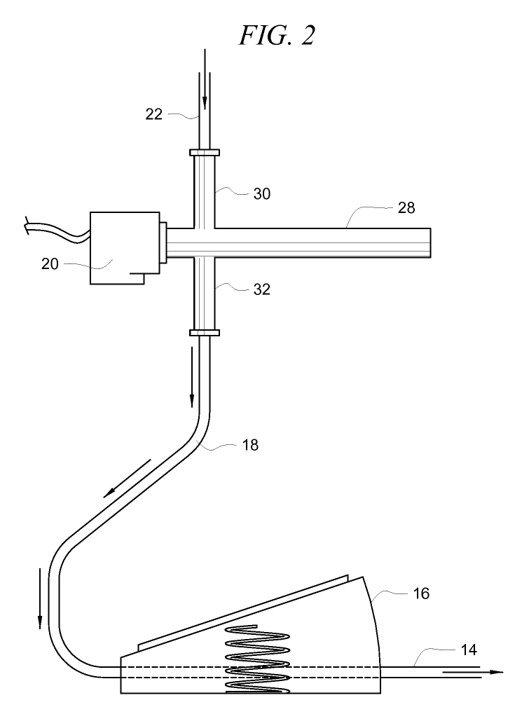

FIG. 2 is similar to FIG. 1 but omits collection tank 12 and reservoir 24. Camera 20 is connected to sheath 28. Hose 22 is connected to inlet stopcock 30 and hose 18 is connected to outlet stopcock 32. In the prior art, inlet stopcock 30 is left open and the surgeon manually opens and closes outlet stopcock 32 as needed during the course of a procedure. Such opening and closing requires the surgeon to put down a surgical tool to free up a hand to manipulate the stopcock. In the novel system, both the inlet stopcock 30 and the outlet stopcock 32 are in their respective fully open configurations for the duration of the procedure. However, the check valve in foot pedal 16 is normally closed so no solution flows even when said stopcocks are open. When fluid flow is desired, the surgeon steps on foot pedal 16, thereby opening the normally closed valve therewithin and enabling flow of sterile solution 24 until the foot is lifted from pedal 16 at which time a spring or other suitable bias means returns the pedal to its normally closed position of repose and fluid flow is terminated. Thus there is no need for the surgeon to put a surgical tool down and to pick it back up again to manipulate a stopcock.

No further disclosure is required to enable those of ordinary skill in the mechanical arts to make and use the invention. Foot pedal 16 can be made in many different ways, and all such ways are within the scope of this invention.

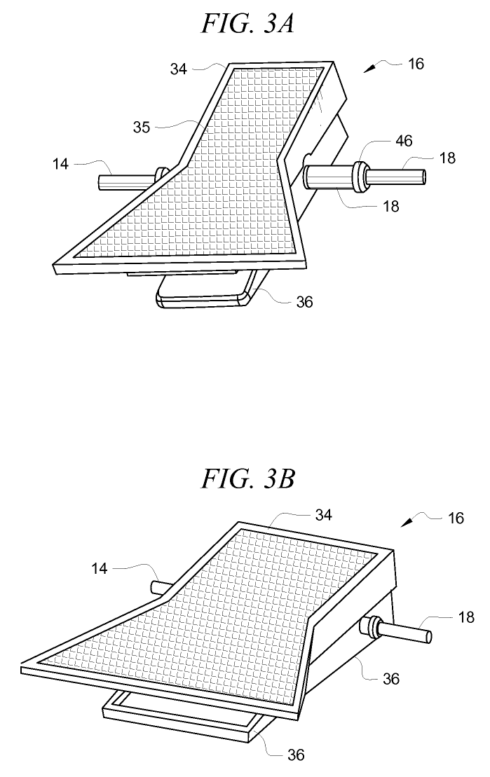

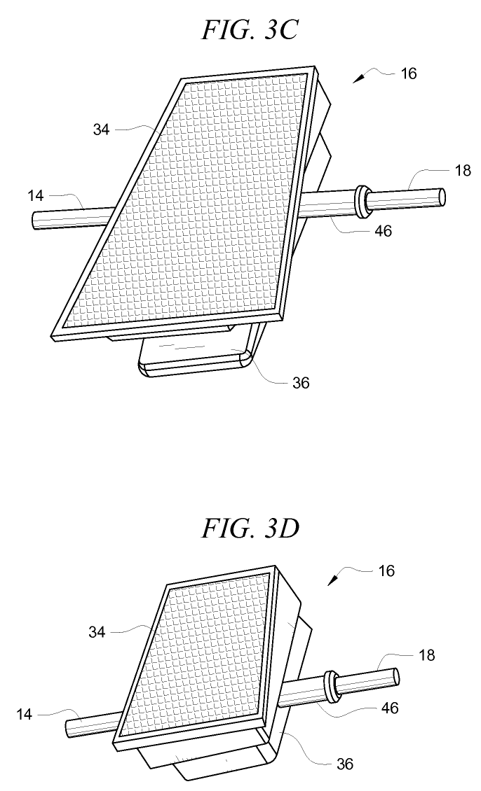

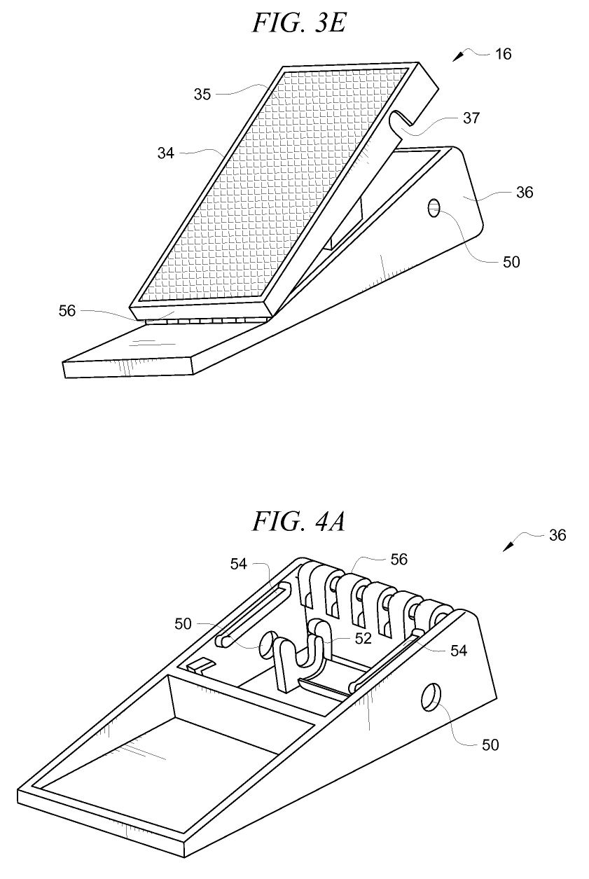

One way of making foot pedal 16 depicted in FIG. 3A. Flat foot-support 34 is pivotally connected to stationary base 36. Surface 35 of foot support 34 is textured to supply a high coefficient of friction to enable rocking motion of foot support 34 about base 36 in the substantial absence of foot slippage.

The width of foot support 34 is increased in FIG. 3B relative to the width thereof in FIG. 3A.

FIG. 3C depicts another alternative embodiment of foot pedal 16. The surface area of the foot support surface 34 is increased to facilitate placement of a user's foot.

FIG. 3D also depicts an alternative embodiment of foot pedal 16. More particularly, FIG. 3D depicts foot pedal 16 of reduced size, enabling the placement of foot pedal 16 in tighter spaces.

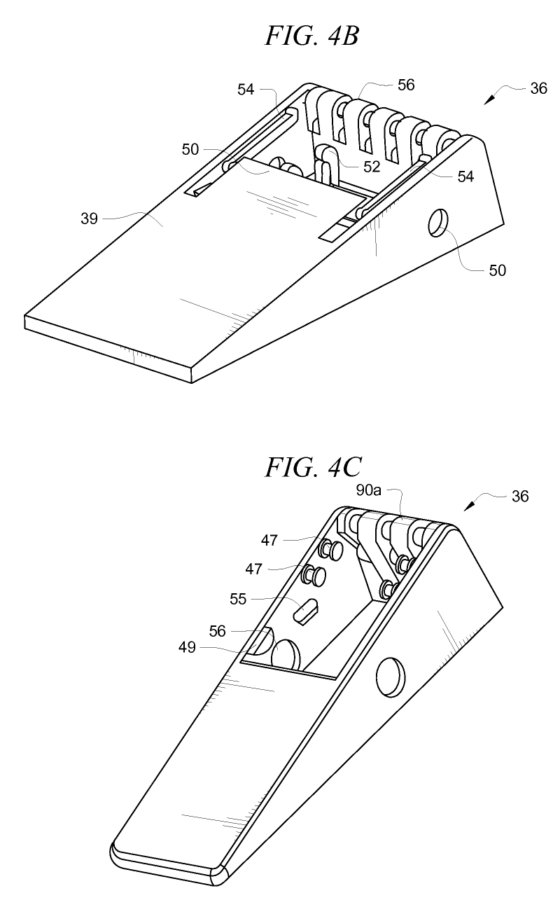

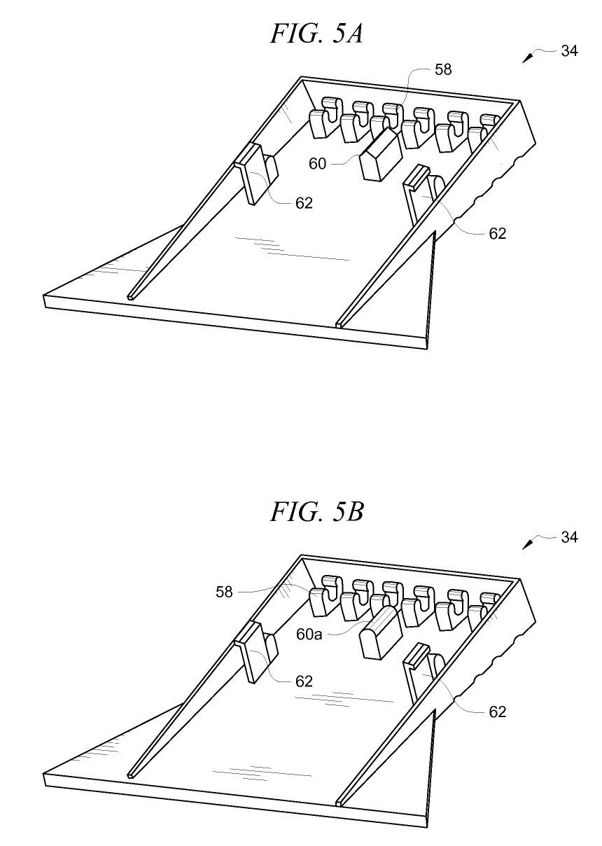

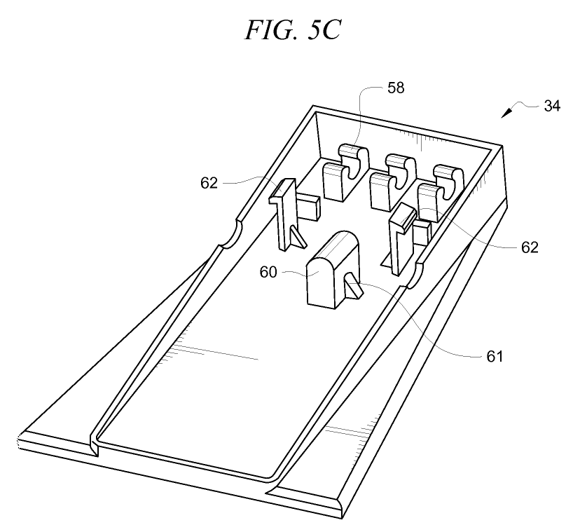

FIG. 3E depicts yet another alternative embodiment of foot pedal 16. As will be better understood in connection with FIGS. 4A-C, and FIGS. 5A-C that follow, the hinged connection between foot support 34 and base 36 is positioned at the proximal end of pedal 16 as distinguished from the distal end as in the other embodiments. Moreover, notch 37 formed in opposing sidewalls of foot support 36 accommodates a valve assembly disclosed hereinafter.

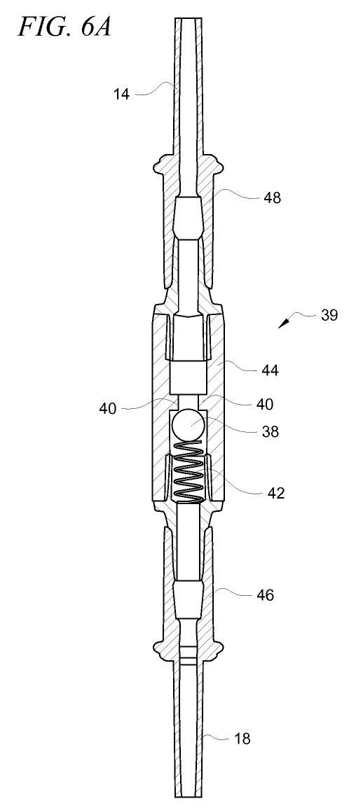

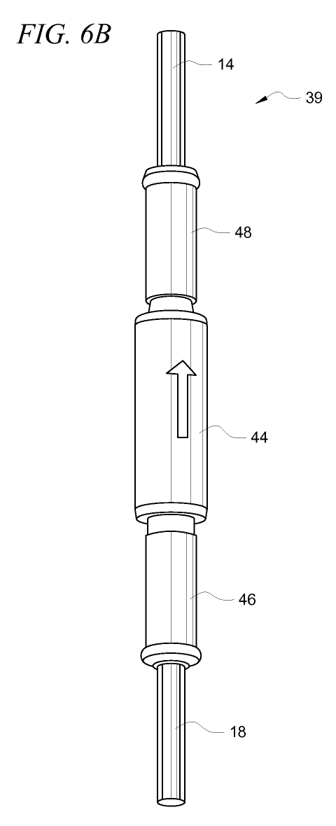

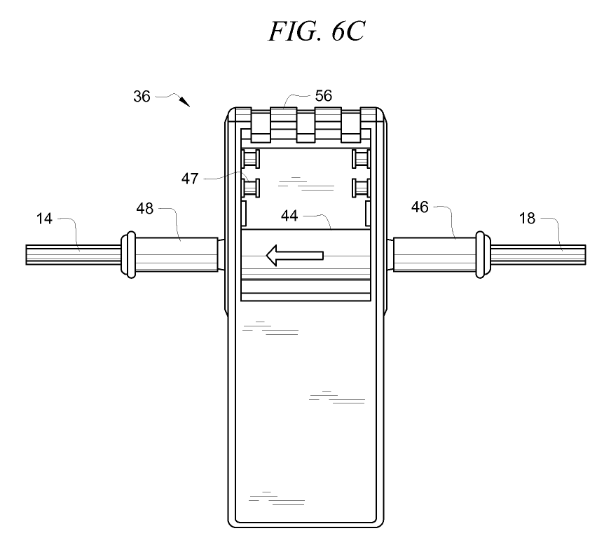

FIG. 4A depicts base 36 in increased detail. Openings 50, 50 accommodate the respective ends of rubber hose attachments 46, 48, disclosed hereinafter in connection with FIGS. 6A-C, that abut opposite ends of rubber tubing 44, also disclosed in connection with said FIGS. 6A-C. Transversely spaced apart clips 52, of which there are two, are formed integrally with base 36 and snugly receive said rubber tubing 44. Springs 54, 54 return foot support 34 to its position of repose when the surgeon's foot is separated from said foot support, thereby causing a check ball, disclosed hereinafter, to return to its annular valve seat so that solution flow terminates in the absence of manual manipulation of the stopcock. Hinge pin 56 is formed integrally with base 38 at its highest end.

In an alternative embodiment of base 36 depicted in FIG. 4B, cover 39 covers the open lower end of said base, leaving clips 52 and hinge pin 56 uncovered. Springs 54 are positioned on the interior of the opposing vertical sidewalls of the base. Said springs return foot support 34 to its undepressed position of repose when released by the user as aforesaid. The opposing sides of the base are embossed “IN” and “OUT” as appropriate adjacent openings 50.

FIG. 4C depicts another alternative embodiment of base 36. It has a relatively narrow structure and is used with a narrow foot support, such as depicted in FIG. 5C. Base 36 includes a pair of knobs 47 that extend into the hollow interior of base 36 from its opposing vertical sidewalls. Rubber bands to aid in the opening of foot support 34 are secured to said knobs 47. Base 36 further includes retaining clips 49 (not shown in drawing), for the valve assembly, positioned adjacent openings 50 that accommodate the inlet and outlet tubes of the valve assembly. Base 36 further includes stop 54 for limiter 62 that forms a part of the foot support embodiment of FIG. 5C.

FIG. 5A depicts the underside of a first embodiment of foot support 34. Socket 58 formed integrally with said underside of said foot support snugly and rotationally receives hinge pin 56 of base 36 to thereby provide the pivotal or rocking motion between foot support 34 and base 36.

Valve actuator 60 is formed integrally with foot support 34 and depends from an underside thereof. A pair of limiters 62 are also integrally formed with said foot support on said underside; said limiters limit the separation between foot support 34 and base 36 when said foot support is in its position of repose. A user will typically rest his or her foot on or near foot pedal 16 during the surgical procedure. The user will begin depression of the pedal with a foot by applying pressure to textured surface 35 of foot support 34 when the user's field of vision is obscured. Upon said depression of foot pedal 16, valve actuator 60 abuts against an annular valve seat disclosed hereinafter to unseat a check ball from said valve seat so that sterile fluid from reservoir 24 may purge the surgical site.

A problem arises if valve actuator 60 over-compresses the valve assembly. More particularly, excess compression can shut the valve off completely. Various solutions to this problem include limiting the depth, or altering the shape of valve actuator 60, or both as depicted in FIG. 5B to ensure the actuator does not over compress the valve. Upon relief of pressure on foot support 34, it separates from base 36 and actuator 60 withdraws from its abutting contact with the valve assembly. A spring, disclosed hereinafter, returns foot pedal 16 to its position of repose, resulting in the suction on the fluid terminating with respect to the fluid at the field of view. In this manner the fluid in the field of view is purged.

FIG. 5B depicts an alternative embodiment of foot support 36 as mentioned above. Valve actuator 60a is modified by rounding off sharp edges from its periphery where it contacts the top of the valve assembly and its depth is reduced to prevent over-compression of the valve.

FIG. 5C illustrates another alternative embodiment of foot support 34. It also includes a pair of limiters 62 that limits the upward separation of foot support 34 from base 36. Each limiter 62 abuts stop 55 of base 36 as depicted in FIG. 4C. Supports 61 strengthen valve actuator 60.

FIG. 6A depicts valve assembly 39 that includes check ball 38 held against annular valve seat 40 by spring 42. Radially inwardly-extending valve seat 40 is formed integrally with rubber tubing 44. Check ball 38 and spring 42 are positioned within the lumen of said rubber tubing 44. The length of rubber tubing 44 is substantially equal to the width of base 36. First rubber hose attachment 46 abuts a first end of rubber tubing 44 and second rubber hose attachment 48 abuts an opposite, second end of rubber tubing 44. Moreover, first rubber hose attachment 46 ensleeves inlet hose 18 and second rubber hose attachment 48 ensleeves outlet hose 14. When the foot pedal is depressed, valve actuator 60 or 60a bears against annular valve seat 40 and distorts it into an oblong or other non-annular configuration so that liquid fluid leaks around spherical ball valve 38.

FIG. 6B depicts valve assembly 39 when not installed on foot pedal 16 and FIG. 6C depicts the valve assembly when installed on base 36 of foot pedal 16.

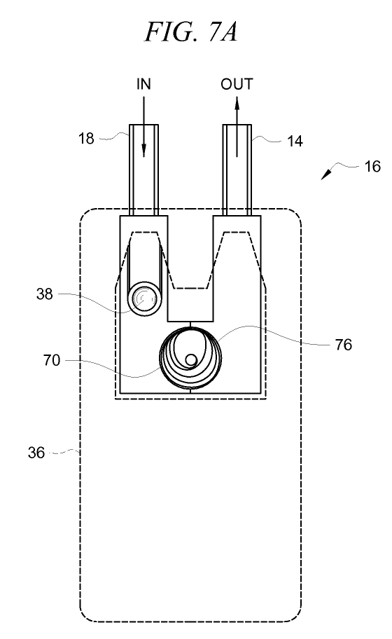

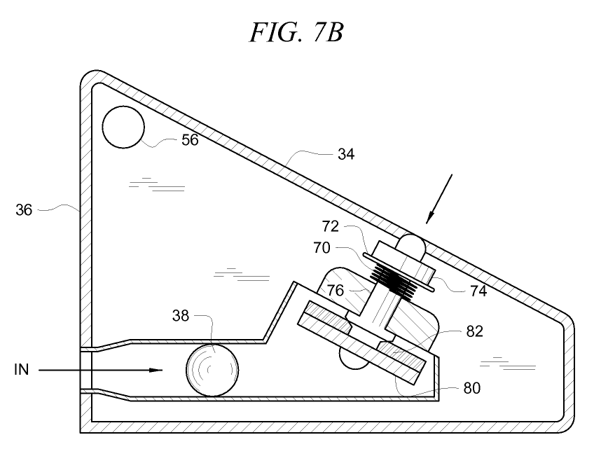

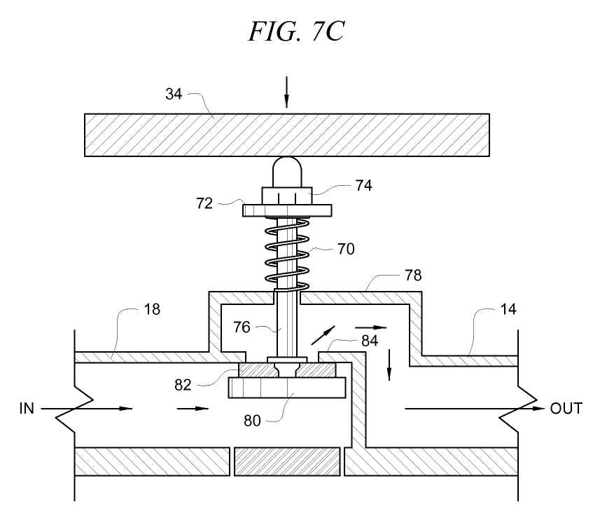

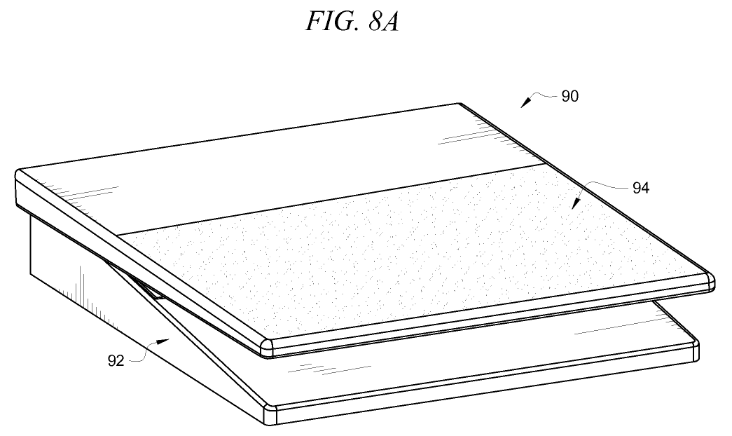

FIGS. 7A-C depict a second embodiment of the novel valve system structure in top, side, and front views, respectively. This novel structure includes outlet and inlet connectors 14, 18, respectively, arranged in parallel relation to one another on the same side of pedal 16 as illustrated in FIG. 7A. Specifically, outlet and inlet tubes 14, 18 are positioned at the distal end of foot pedal 16, i.e., in a location remote to the toes of a user. This arrangement reduces the clutter of the lines around the user's feet and therefore provides a greater degree of safety.

As perhaps best understood in connection with FIG. 7C, spring 70 urges washer 72 upwardly. Nut 74 limits the maximum expansion of said spring 70. Spring 70 ensleeves post 76 which is supported by boss 78. Post 76 is displaced downwardly when foot support 34 is depressed, thereby loading spring 70. Check valve 80, sealed by rubber O-ring 82, is unseated from annular valve seat 84 when said post is depressed, thereby allowing sterile fluid to flow from reservoir 24 to collection tank 12 as indicated by the plurality of flow arrows.

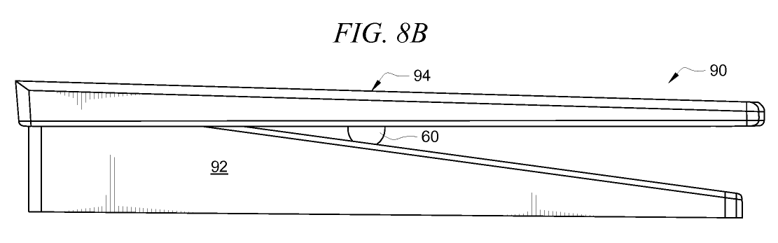

FIGS. 8A-B and 9A-D depict a third embodiment, denoted 90 as a whole. Foot pedal 90 includes base 92 and foot support 94 that are hingedly connected to one another along a top or distal edge thereof.

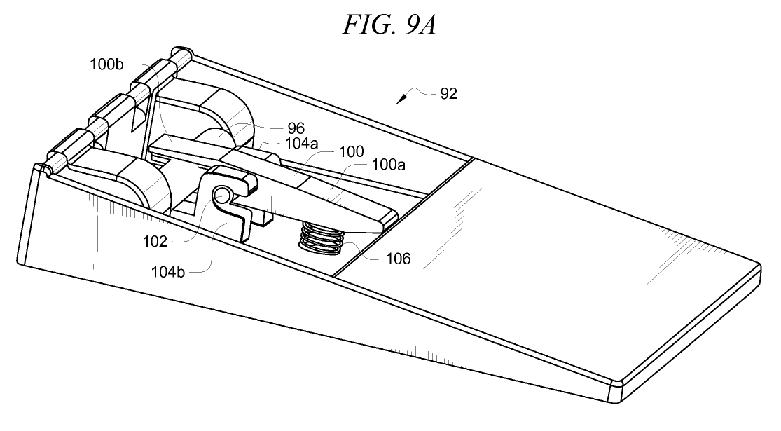

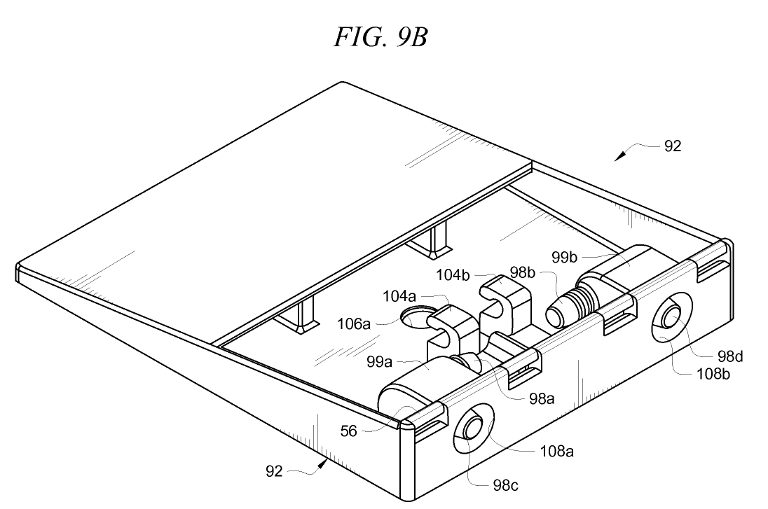

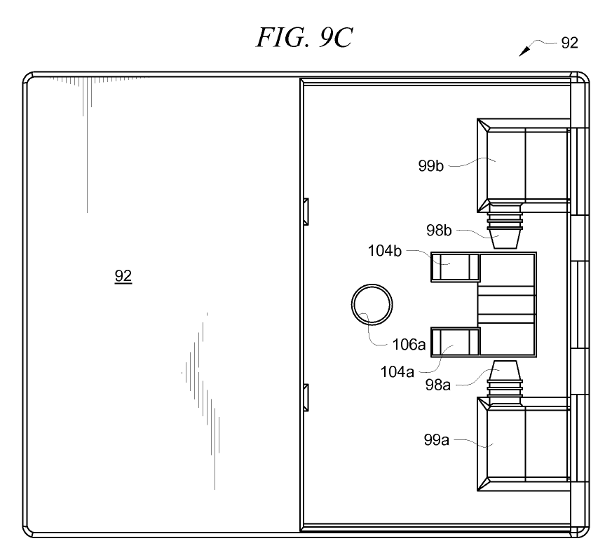

As best understood in connection with FIGS. 9A-D, this embodiment eliminates the ball check valve of the first and second embodiments. Truncate tube 96 is formed of a compressible, flexible and resilient material such as rubber, elastomeric plastic or the like and is attached at its opposite ends to tube mounts 98a, 98b (FIGS. 9B-C) and as depicted in FIG. 9A, tube 96 is pinched and normally closed by spring-loaded lever 100. Transversely disposed pin 102 extends through lever 100 and the opposite ends of said pin are rotatably retained by transversely spaced apart retainers 104a, 104b. Spring 106 or other suitable bias means provides constant upward pressure on the trailing end 100a of lever 100 so that leading end 100b of lever 100 bears downwardly against tube 96, thereby pinching it so that no liquid fluid can flow through said tube. A suitable, preferably bulbous, protrusion having a linear extent greater than the diameter of tube 96 is formed on the underside of leading end 100b to facilitate the pinching action.

As best understood in connection with FIG. 8B, valve actuator 60 depends from an underside of foot pedal 94 and abuttingly engages trailing end 100a or lever 100 so that full depression of said foot support 94 lifts leading end 100b of lever 100 from truncate tube 96 so that liquid fluid may flow therethrough. A physician controls the rate of fluid flow by manipulating the amount of compression of spring 106. A shallow recess 106a (FIGS. 9B-C) is formed in a bottom wall of base 92 to accept a lower end of said spring.

Tube mounts 98a, 98b are housed in housings 99a, 99b and have a ninety degree (90°) bend formed in them as best understood in connection with FIG. 9B. The respective ends 98c, 98d of said mounting tubes that do not engage truncate tube 96 are flush with the distal end of base 92 and are concentrically positioned within countersunk openings 108a, 108b. Inlet hose 18 is thus easily connected to tube mount 98c and outlet hose 14 is easily connected to tube mount 98d. This is the same connection made in the embodiment of FIGS. 7A-C.

Pedals 16 or 90 can be made of reasonably inexpensive components, thus making it suitable for disposal following a single surgical procedure. Valve assembly 39 can be single use as well. Pedal 16 may also be sterilized and a new valve added after each procedure.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A foot-actuated control valve, comprising:
a valve assembly including a normally closed valve;
a base adapted to house the valve assembly;
a foot support hingedly secured to the base;
said foot support having a position of repose where said normally closed valve is closed;
said foot support having a displaced position where said normally closed valve is open;
said foot support including a valve actuator adapted to open the normally closed valve upon application of pressure to the foot support by a user;
an inlet hose in fluid communication with said valve assembly, said inlet hose adapted to provide fluid communication between an inlet of said valve assembly and a remote source of a sterile fluid; and
an outlet hose in fluid communication with said valve assembly, said outlet hose adapted to provide fluid communication between an outlet of said valve assembly and a remote collection tank for collecting said sterile fluid.

2. The foot-actuated control valve of claim 1, further comprising:
said valve assembly including a tubular housing having a radially-inwardly extending annular valve seat formed therein;
said valve assembly further including a ball check valve adapted to prevent fluid flow through said tubular housing when said ball check valve is seated in said annular valve seat;
an inlet connector disposed in axial alignment with said tubular housing in abutting relation thereto on an inlet side of said tubular housing;
an outlet connector disposed in axial alignment with said tubular housing in abutting relation thereto on an outlet side of said tubular housing;
said inlet connector being connected to said inlet hose;
said outlet connector being connected to said outlet hose;
said inlet hose providing fluid communication between said remote source of sterile fluid and said inlet connector and hence said tubular housing;
said outlet hose providing fluid communication between said outlet connector and hence said tubular housing and said remote collection tank.

3. The foot-actuated control valve of claim 2, further comprising:
a bias means disposed in interconnecting relation between said foot support and said base;
said bias means being compressed when said foot pedal is compressed by a user;
said bias means, under inherent resilience, returning said foot support to said position of repose when said foot pedal is not compressed by a user.

4. The foot-actuated control valve of claim 1, further comprising:
a pair of clips formed integrally with said base of said foot pedal;
said pair of clips adapted to snugly engage said valve assembly.

5. The foot-actuated control valve of claim 2, further comprising:
a valve actuator formed in said foot support on an underside thereof so that when said foot support is displaced by the foot of a user, said valve actuator abuttingly engages said annular ball check valve seat and distorts said annular ball check valve seat so that it assumes a non-annular configuration that opens said valve assembly so that said sterile fluid flows from said remote reservoir to said remote collection tank through said field of view of said camera.

6. The foot-actuated control valve of claim 1, further comprising:
said valve assembly including a truncate tube formed of a compressible, flexible and resilient material;
a first end of said truncate tube adapted to be in fluid communication with said remote source of sterile fluid;
a second end of said truncate tube adapted to be in fluid communication with said remote collection tank;
a lever mounted in said base, said lever having a position of repose where a leading end of said lever compresses said truncate tube so that liquid fluid cannot flow therethrough;
said valve actuator depending from an underside of said foot support and bearing against a second end of said lever when said foot support is depressed so that said lever rotates from said position of repose, thereby enabling liquid fluid flow through said truncate tube.

7. The foot-actuated control valve of claim 6, further comprising:
a first tube mount secured to said base, said first tube mount having a first end adapted to engage a first end of said truncate tube;
a second tube mount secured to said base, said second tube mount having a first end adapted to engage a second end of said truncate tube;
said first tube mount having a ninety degree (90°) bend formed therein;
said second tube mount having a ninety degree (90°) bend formed therein;
said first tube mount having a second end adapted to engage said inlet hose;
said second tube mount having a second end adapted to engage said outlet hose;
whereby said inlet and outlet hoses are disposed in parallel relation to one another.
